(19) United States
(12) Patent Application Publication
(10) Pub. No.: US 2025/0383237 A1
(43) Pub. Date: Dec. 18, 2025

(54) THERMAL DETECTOR COMPRISING A SUSPENDED ABSORBING MEMBRANE WITH A LOOP ELECTRODE

(71) Applicant: COMMISSARIAT A L'ENERGIE ATOMIQUE ET AUX ENERGIES ALTERNATIVES, Paris (FR)

(72) Inventors: Olivier PEYSSONNEAUX, Grenoble cedex 09 (FR); Valérie GOUDON, Grenoble Cedex 09 (FR); Thomas PERRILLAT-BOTTONET, Grenoble Cedex 09 (FR); Mélanie LE COCQ, Grenoble Cedex 09 (FR); Claire VIALLE, Grenoble Cedex 09 (FR); Antoine SCHEMBRI, Grenoble Cedex 09 (FR); Gaelle CHAMIOT-MAITRAL, Grenoble Cedex 09 (FR); Jean-Jacques YON, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 19/241,057

(22) Filed: Jun. 17, 2025

(30) Foreign Application Priority Data
Jun. 18, 2024 (FR) FR2406451

(51) Int. Cl. G01J 5/22; H01C 1/14; H01C 7/00

(52) U.S. Cl. CPC G01J 5/22; H01C 1/14; H01C 7/008

(57) ABSTRACT

A thermal detector comprising an absorbing membrane suspended above a readout substrate, which comprises a thermistor layer resting on two electrodes. The first electrode is a looped track, and the second electrode comprises a central part and a radial track. Furthermore, the thermistor layer has a peripheral contact zone in contact with the first electrode and a central contact zone in contact with the central part; the thermistor layer being electrically insulated from the radial track.

### TECHNICAL FIELD

The invention relates to the field of thermal detectors for detecting an electromagnetic radiation, for example infrared or terahertz, comprising an absorbing membrane which is suspended above a readout substrate and thermally insulated from the latter. In particular, the invention applies to the fields of infrared imaging, thermography, gas detection, inter alia.

### PRIOR ART

Thermal detectors are adapted to detect an electromagnetic radiation, for example infrared or terahertz. For this purpose, they can comprise an absorbing membrane, suspended above a readout substrate, comprising an absorber of the electromagnetic radiation to be detected, and a thermometric transducer, for example a thermistor layer, thermally coupled to the absorber.

To ensure the thermal insulation of the thermistor layer with respect to the readout substrate, the absorbing membrane is usually suspended above the readout substrate by anchoring pillars, and is thermally insulated from it by holding arms. These anchoring pillars and holding arms also have an electrical function insofar as they make it possible to connect the thermistor layer to the readout circuit located in the substrate.

The holding arms can be formed of a stack of two thin insulating layers, made of a thermally and electrically insulating material, between which is located a thin conductive layer made of an electrically conductive material. This thin conductive layer forms, in the absorbing membrane, the electrodes making it possible to connect the thermistor layer to the readout circuit.

FIG. 1A and FIG. 1B are top and cross-sectional views of a thermal detector 1 according to an example of the prior art, here adapted to absorb an infrared radiation of the LWIR (Long Wave Infrared) spectral band, the central wavelength of which is between about 8 μm and 14 μm.

The thermal detector 1 comprises an absorbing membrane 50 suspended above a readout substrate 10 by anchoring pillars 20 and thermally insulated from it by holding and thermal insulation arms 30. These anchoring pillars 20 and holding arms 30 also have an electrical function by electrically connecting the absorbing membrane 50 to a readout circuit located in the readout substrate 10.

The absorbing membrane 50 here comprises a thermistor layer 53 in contact with two thin-layer electrodes 51, 52. The thermistor layer 53 is also in thermal contact with an absorber 54 adapted to absorb the electromagnetic radiation to be detected. The thermistor layer 53 is made of a material having an electrical resistance which varies with its own heating. The absorbing membrane 50 is vertically spaced apart from a reflector 12 by a determined distance so as to form a quarter-wave interference cavity optimizing the absorption by the absorber 54 of the electromagnetic radiation to be detected.

It is usually sought to minimize the electrical resistance of the thermistor layer. Indeed, in particular in the case of a voltage-biased thermal detector, this allows improving the performances, notably in terms of the NETD parameter, which corresponds to the Noise Equivalent Temperature Difference.

In the example of FIGS. 1A and 1B, the thermistor layer 53 is a rectangular layer and the two electrodes 51, 52 have rectilinear inner edges facing and parallel with each other. The thermistor layer 53 is then in contact with the electrodes at these edges. Thus, it has an electrically biased volume with lateral dimensions L and W and thickness h. The dimension L is measured between the contact zones of the thermistor layer with the electrodes, whereas the dimension W corresponds to the width of the thermistor layer 53. It is apparent that the dimension L is limited by the inter-electrode insulation (which is particularly dependent on the nature of the thin insulating layer on which the thermistor layer rests), and the width W is limited by the dimensions of the detection pixel. When the dimension L is substantial, the biased volume of the thermistor layer 53 is substantial, which allows avoiding having an excessively high 1/f noise. On the other hand, the electrical resistance R of the thermistor layer 53 is not optimal, due in particular to the low value of the width W which cannot extend beyond the dimension of the pixel. Let us recall here that the electrical resistance depends on the L/W ratio by the relationship: R=(ρ/h)×(L/W), where ρ is the resistivity of the thermistor layer material, and h is its thickness.

FIG. 2 is a top view of a thermal detector 1 according to another example of the prior art. Here, the thermistor layer 53 is once again a rectangular layer, but the two electrodes 51, 52 have an interdigitated shape: the spacing between the electrodes 51, 52 have a serpentine shape with the dimensions L and W. Here, the L/W ratio is minimum, which allows optimizing the electrical resistance R of the thermistor layer 53. On the other hand, the biased volume thereof is reduced compared to that of the parallelepiped configuration of FIG. 1A, which results in a greater 1/f noise.

### DISCLOSURE OF THE INVENTION

An objective of the invention is to at least partially overcome the drawbacks of the prior art, and more particularly provide a thermal detector that has improved performances in terms of NETD (or NEP, Noise Equivalent Power) parameter, and in particular in terms of electrical resistance R of the thermistor layer and 1/f noise.

For this purpose, the invention relates to a thermal detector comprising a readout substrate and an absorbing membrane. The latter is suspended above the readout substrate, and electrically connected and thermally insulated from it. It comprises a first and a second thin-layer electrodes, and a thermistor layer located on and in contact with the electrodes.

According to the invention, the first electrode is a looped track extending along the periphery of the absorbing membrane. The second electrode is formed of: a central part, located at the center of the first loop electrode, and partially surrounded by it; and a radial track from the central part to an edge of the absorbing membrane. Moreover, the thermistor layer has: a peripheral contact zone, extending along the first loop electrode, where it is in contact with it; and a central contact zone, located at the center of the peripheral contact zone and partially surrounded by it, where it is in contact with the central part of the second electrode, the thermistor layer being electrically insulated from the radial track.

Some preferred, yet non-limiting, aspects of this thermal detector are as follows.

The peripheral contact zone can have an inner edge parallel and concentric with an outer edge of the central contact zone.

The inner edge of the peripheral contact zone and the outer edge of the central contact zone can be circular.

The thermistor layer can have a circular shape concentric with the inner edge of the peripheral contact zone and with the outer edge of the central contact zone.

The first electrode can have an inner edge parallel and concentric with an outer edge of the central part of the second electrode.

The inner edge of the first electrode and the outer edge of the central part of the second electrode can be circular.

The absorbing membrane can comprise a thin insulating layer located between the thermistor layer and the radial track of the second electrode.

The central part of the second electrode may be located at the center of the absorbing membrane.

The thermistor layer and the electrodes can be configured such that a parameter Z=R×h/ρ is less than or equal to 0.3, where R is the electrical resistance of the thermistor layer, h its mean thickness, and ρ the resistivity of the material of the thermistor layer.

The first electrode and the radial track of the second electrode can be coplanar, the first electrode extending in an open loop which comprises an opening wherein the radial track extends.

The thermistor layer can have an angular notch located perpendicular to the opening of the first electrode.

The first electrode and the radial track of the second electrode may not be coplanar, the first electrode extending in a closed loop, the radial track being vertically spaced apart from the first electrode by an interposed thin insulating layer.

### BRIEF DESCRIPTION OF THE DRAWINGS

Other aspects, aims, advantages and features of the invention will become apparent upon reading the following detailed description of preferred embodiments thereof, provided as a non-limiting example, and made with reference to the appended drawings wherein:

FIG. 1A and FIG. 1B, already described, are schematic and partial views, respectively as a top view and as a cross-section along the line AA, of a thermal detector according to an example of the prior art where the thermistor layer and electrodes have a parallelepiped configuration;

FIG. 2, already described, is a schematic and partial cross-sectional view of a thermal detector according to another example of the prior art where the electrodes of the absorbing membrane have an interdigitated configuration;

FIG. 3A and FIG. 3B are schematic and partial views, respectively as a top view and as a cross-sectional view along the line AA, of a thermal detector according to an embodiment where one of the electrodes has an annular open-loop configuration;

FIG. 4A and FIG. 4B are schematic and partial views, respectively as a top view and as a cross-sectional view along the line AA, of a thermal detector according to an embodiment where the absorber is separate from the electrodes, and where the thermistor layer has a thickness variation;

FIG. 5A is a schematic and partial top view of a thermal detector according to another embodiment where the thermistor layer has an angular notch;

FIG. 5B illustrates an example of accessible domains, according to the electrical resistance R and the biased volume V of the thermistor layer, in the case of a parallelepiped configuration and in the case of two open-loop configurations for a thermistor material of given resistivity and thickness;

FIG. 6 is a schematic and partial top view of a thermal detector according to another embodiment where one of the electrodes has a rectangular open-loop configuration;

FIG. 7A and FIG. 7B are schematic and partial views, respectively as a top view and as a cross-sectional view along the line AA, of a thermal detector according to another embodiment where one of the electrodes has a closed-loop configuration.

### DETAILED DISCLOSURE OF PARTICULAR EMBODIMENTS

In the figures and in the following description, the same references represent identical or similar elements. In addition, the different elements are not plotted to scale so as to favor clarity of the figures. Moreover, the different embodiments and variants are not mutually exclusive and could be combined. Unless stated otherwise, the terms “substantially”, “about”, “in the range of” mean within a 10% margin, and preferably within a 5% margin. Moreover, the terms “between . . . and . . . ” and equivalents mean that the bounds are included, unless stated otherwise.

The invention relates to a thermal detector for detecting an electromagnetic radiation, for example infrared or terahertz, in particular in the LWIR range (8-14 μm), comprising an absorbing membrane suspended above a readout substrate. The absorbing membrane is thermally insulated from the latter and electrically connected to a readout circuit located in the substrate. In particular, it comprises a thermistor layer and two thin-layer electrodes which ensure its electrical biasing.

The thermal detector according to the invention has improved performances, in particular in terms of noise equivalent temperature difference (NETD, standing for Noise Equivalent Temperature Difference). Note that the performances could also be assessed here in terms of Noise Equivalent Power (NEP, standing for Noise Equivalent Power).

For this purpose, the first electrode is a looped track (open or closed), which extends along the periphery of the absorbing membrane. It extends along the periphery (i.e. the perimeter) of the absorbing membrane, and preferably along all sides of the absorbing membrane. The periphery (perimeter) of the absorbing membrane is the line that delimits the membrane in a plane XY. The first electrode may open out onto the periphery or be spaced apart from it in the plane XY. By “track”, it should be understood a thin layer in strip form, i.e. its length is larger than its width. As the track is a thin layer, its thickness is less than its length and its width. Moreover, the track extends in a loop shape, i.e. it extends longitudinally around a central zone (hence the loop or annular shape).

Furthermore, the second electrode is formed of a central part, located at the center of the first loop electrode, and partially surrounded by it (in the same plane or in a different plane). By “located at the center”, it should be understood that the central part is located at a middle position at each point of an inner edge of the first loop electrode. The second electrode is also formed of a radial track and connecting the central part to an edge of the absorbing membrane (this edge helps define the periphery/perimeter of the membrane). It provides the electrical junction between the central part and the holding arm wherein the thin conductive layer of the second electrode extends.

The first loop electrode can have an open-loop or closed-loop configuration:
In the case of an open loop, the first electrode is not closed on itself: it has a so-called angular opening which extends over the entire width of the looped track. In this configuration, the first electrode and the second electrode (central part and radial track) can be coplanar: the radial track of the second electrode then extends into the angular opening of the first open-loop electrode.
In the case of a closed loop, the first electrode is closed on itself, and therefore has no angular opening. To prevent any short circuit between the electrodes, the radial track of the second electrode is not coplanar with the first closed-loop electrode and extends above or below the first electrode. Preferably, the central part of the second electrode is coplanar with the radial track (and is therefore not coplanar with the first electrode).

Finally, the thermistor layer extends over and in contact with the two electrodes. More specifically, it has a peripheral contact zone, which extends along the first loop electrode, where it is in contact with the latter. It also has a central contact zone, located at the center of the peripheral contact zone and partially surrounded by the peripheral contact zone, where it is in contact with the central part of the second electrode.

Thus, this geometric configuration of the two electrodes and of the thermistor layer, where the first electrode is open- or closed-loop, allows optimizing the electrical resistance R of the thermistor layer, while maintaining a sufficient volume V of the electrically biased thermistor layer so as not to generate more 1/f noise. Thus, the NETD and therefore the performances of the thermal detector are optimized.

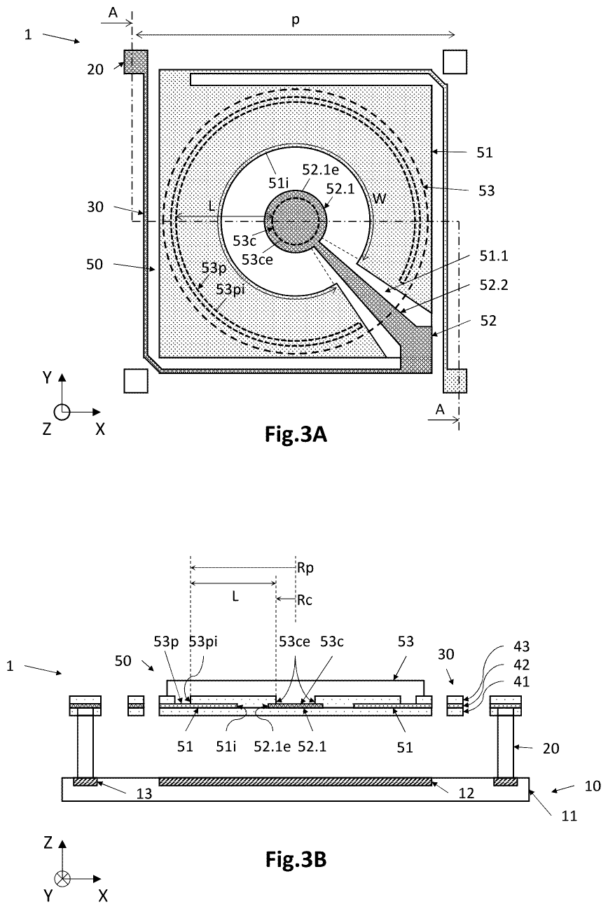

FIG. 3A and FIG. 3B are schematic and partial views, respectively as a top view and as a cross-section along the sectional line AA, of a thermal detector 1 according to one embodiment. In this example, the first electrode 51 extends in an open loop. It is therefore coplanar with the radial track 52.2 (and with the central part 52.1) of the second electrode 52.

Here and hereinafter in the description, a three-dimensional direct reference frame XYZ is defined, where the plane XY is substantially parallel with the plane of a readout substrate 10 of the thermal detector 1, the axis Z being oriented along a direction substantially orthogonal to the plane XY, from the readout substrate 10 toward the absorbing membrane 50. Moreover, the terms “lower” and “upper” should be understood as relating to an increasing positioning when getting away from the readout substrate 10 in the direction +Z.

The thermal detector 1 can belong to an array of identical thermal detectors, preferably arranged periodically in a plane XY. Each thermal detector forms a detection pixel. The absorbing membranes then rest on the same readout substrate. In the case of infrared detection, the array may comprise for example between 60×80 and 1,280×1,024 pixels, with a repetition step p which may be in the range of 10 μm for example.

The thermal detector 1 comprises an absorbing membrane 50, suspended above the readout substrate 10 by anchoring pillars 20, and thermally insulated from the latter by holding arms 30. The anchoring pillars 20 and holding arms 30 also fulfill an electrical connection function of the thermistor layer 53 to the readout circuit contained in the readout substrate 10.

The readout substrate 10 is formed of a support substrate 11 containing the readout circuit (not shown) adapted to control and read the thermistor layer 53. The readout circuit may be in the form of a CMOS integrated circuit. It thus comprises active microelectronic elements (for example transistors, diodes, amplifiers, etc.) and electrical interconnection levels. Only the upper interconnection level is shown here. The interconnection levels are formed of conductive lines or portions vertically connected by conductive vias (not shown). The conductive portions and the conductive vias may be made based on copper, aluminum and/or tungsten, inter alia, for example by means of a Damascene process wherein trenches made in inter-metal insulating layers are filled. These can be produced based on silicon oxide (SiO₂, SiOF, SiOC, SiOCH, etc.) and optionally silicon nitride SiN.

Here, conductive portions of the upper interconnection level form a reflector 12 as well as connection portions 13 of the anchoring pillars 20. The reflector 12 is adapted to reflect the electromagnetic radiation to be detected in the direction of the absorbing membrane 50, and therefore extends in the plane XY facing it (and more specifically facing the absorber of the absorbing membrane 50). The vertical spacing between the absorbing membrane 50 (and more specifically the absorber) and the reflector 12 makes it possible to form a quarter-wave optical interference cavity which maximizes the absorption of the electromagnetic radiation to be detected.

A barrier layer (not shown), for example made of SiN, can cover the support substrate 11 and the upper interconnection line. It makes it possible to prevent the diffusion of the metal from the portions of the upper interconnection line to the upcoming upper layers. Finally, a protective layer (not shown) can cover the barrier layer, and therefore also the support substrate 11 and the readout circuit (with the inter-metal insulating layers and the interconnecting lines). This protective layer is made of a material substantially inert to an etching agent subsequently used to remove the sacrificial layer(s) (for example hydrofluoric acid in vapor phase). It can for example be made of Al₂O₃ with a thickness of about 20 to 40 nm, or of AlN with a thickness of about 100 nm.

The anchoring pillars 20 extend along the direction +Z so as to space the absorbing membrane 50 apart by a predefined distance with respect to the readout substrate 10 and the reflector 12. They are made of an electrically-conductive material, for example based on tungsten or copper. They are formed of a conductive via each topped with an upper conductive pad, for example made of TiN with a thickness of about 20 to 50 nm. This pad prevents diffusion of the material from the conductive vias. Each conductive via can also comprise a thin layer (not shown), extending to the periphery of the via in the plane XY and made for example of TiN, making it possible to prevent diffusion of the material from the vias.

The holding arms 30 are formed of a stack of at least a thin insulating layer 41, and a thin conductive layer 42 made of an electrically conductive material. In this example, the stack comprises a lower thin insulating layer 41, a thin conductive layer 42, and an upper thin insulating layer 43. This stack is also found on the anchoring pillars 20 as well as in the absorbing membrane 50.

The thin insulating layers 41, 43 are preferably made of the same material, for example of amorphous silicon, silicon nitride, aluminum nitride, inter alia, and preferably have the same thickness. This thickness can be between 10 nm and 100 nm, preferably between 30 nm and 70 nm, for example equal to about 50 nm. It can be adjusted where required, according to the width and length of the holding arms 30, so as to ensure good mechanical stability thereof.

The thin conductive layer 42 extends into the holding arms 30 and partially into the absorbing membrane 50 to form the two electrodes 51, 52 therein. It is made of an electrically-conductive material, for example made of at least one metallic material like TiN or NiCr, inter alia, and has a thickness for example between 5 and 15 nm, preferably between 6 and 10 nm.

The absorbing membrane 50 comprises a thermistor layer 53, i.e. a layer made of a material wherein the electrical resistance varies according to its own thermal heating, the two biasing electrodes 51, 52, and at least one absorber (formed here of the electrodes 51, 52) thermally coupled to the thermistor layer 53.

The absorbing membrane 50 comprises a portion of the stack of the two thin insulating layers 41, 43 and the thin conductive layer 42. Here, the lower thin insulating layer 41 forms the support layer of the absorbing membrane 50.

The biasing electrodes 51, 52 are here two separate parts of the same thin conductive layer 42. They are coplanar here. They have a geometry where the first electrode 51 forms an open-loop track which surrounds a central part 52.1 of the second electrode 52. Furthermore, the angular opening 51.1 of the first electrode allows the radial track 52.2 of the second electrode 52 to pass.

The first electrode 51 extends along the periphery of the absorbing membrane 50 and has an open-loop track shape. It partially surrounds the central part 52.1 of the second electrode 52 (in the same plane XY) and allows its radial track 52.2 to pass through its angular opening 51.1. The angular opening 51.1 has a sufficient size to ensure good electrical insulation with the radial track 52.2 of the second electrode 52.

The first electrode 51 is delimited in the plane XY by an inner edge 51i, oriented toward the central part 52.1 of the second electrode 52, and an opposite outer edge which is here identical to the edge of the absorbing membrane 50. A lateral edge connects the two inner and outer edges, and laterally delimits (along an orthoradial direction) the angular opening 51.1 of the looped track. The inner edge 51i preferably has a circular shape, but other shapes are possible, such as a polygonal shape, for example rectangular or square.

The second electrode 52 is formed of a central part 52.1 and a radial track 52.2. The central part 52.1 is located at the center of the first open-loop electrode 51, and is here also located at the center of the absorbing membrane 50. It is therefore partially surrounded by the first electrode 51. It is delimited in the plane XY by an outer edge 52.1e. The latter preferably has a circular shape, but alternatively can have a polygonal shape, for example rectangular or square. Its shape is preferably correlated with that of the inner edge 51i of the first electrode 51, such that the outer edge 52.1e is parallel with the inner edge 51i. In other words, the outer edge 52.1e and the inner edge 51i are preferably both circular, or, alternatively, polygonal and parallel with each other.

The radial track 52.2 extends longitudinally in the angular opening 51.1 of the first electrode 51, from the central part 52.1 to a junction of the absorbing membrane 50 with the holding arm 30 associated with the second electrode 52. It consists of a track, or a strip, as its length is greater than its width. Preferably, it extends in a rectilinear manner. It may have a constant width or, like in the case here, a width that increases when getting away from the central part 52.1. This radial track 52.2 is electrically insulated from the thermistor layer 53: in this example, the thermistor layer 53 covers the radial track 52.2 but is spaced apart (and therefore electrically insulated) from it by a portion of the upper thin insulating layer 43.

The upper thin insulating layer 43 here covers the electrodes 51, 52 as well as the spacing between them. It extends continuously, in the plane XY, in the holding arms 30 to the absorbing membrane 50, and has a sufficient thickness to ensure good mechanical stability of the absorbing membrane. This thickness can thus be between 15 nm and 100 nm, preferably between 30 nm and 70 nm, for example equal to about 50 nm. The upper thin insulating layer 43 has through openings emerging at the electrodes 51, 52, so as to allow the thermistor layer 53 to come into contact with the electrodes.

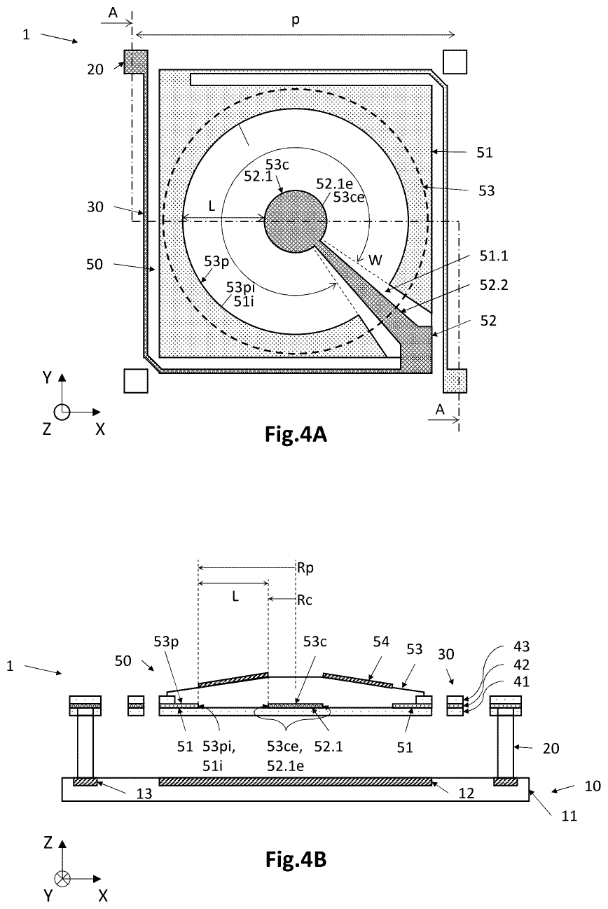

However, as illustrated in FIG. 4B (described hereinafter), note that the upper thin insulating layer 43 can be omitted in the radial inter-electrode spacing if the spacing is sufficient and if the electrical resistivity of the lower thin insulating layer 41 and that of the thermistor layer 53 are sufficient to ensure good electrical insulation between the two electrodes 51, 52. Thus, it can be absent between the inner edges 51i and outer edges 52.1e, but be present in the angular opening 51.1 of the first open-loop electrode 51, i.e. in the orthoradial inter-electrode spacing.

The thermistor layer 53 (shown as a dotted line in FIG. 3A) is here a material with a thickness, for example, in the order of some tens to hundreds of nanometers. It can be a material based on vanadium or titanium oxide, amorphous silicon, or an amorphous silicon-germanium compound. In the case of silicon-germanium, vanadium or titanium oxide, additional layers for protection against HF vapor are provided for (not shown here, for the sake of clarity of the figures).

The electrical resistivity of the amorphous silicon thermistor layer 53 is for example between 60 Ω·cm and 1,000 Ω·cm, for example equal to 60 Ω·cm or about 75 Ω·cm. In the case of silicon-germanium, the electrical resistivity is for example between 10 Ω·cm and 75 Ω·cm, for example equal to 10 Ω·cm (in the case of a rolling shutter type read mode). The electrical resistivity can be adjusted by doping at growth, and by the atomic proportion of germanium where applicable. The thickness of such a thermistor layer 53 can be in the order of some tens to hundreds of nanometers.

The thermistor layer 53 here extends on the upper thin insulating layer 43. It comes into contact with the two electrodes 51, 52 via through openings. Thus, it has a peripheral contact zone 53p which extends along the first electrode 51 in an open loop, where it comes into contact with the latter. It preferably extends over substantially the entire length of the first electrode 51.

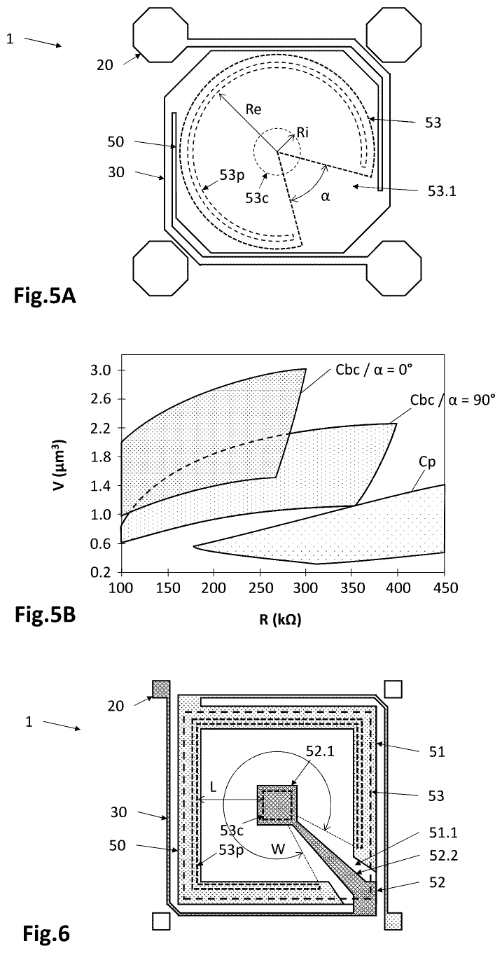

The thermistor layer 53 also has a central contact zone 53c, located at the center of the peripheral contact zone 53p and partially surrounded by it, where it comes into contact with the central part 52.1 of the second electrode 52. The thermistor layer 53 is electrically insulated from the radial track 52.2. For this purpose, insofar as the thermistor layer 53 here has a continuous circular shape (with no angular notch as illustrated in FIG. 5A), a portion of the upper thin insulating layer 43 entirely covers the radial track 52.2 so as to prevent any contact of the thermistor layer 53 with it.

Preferably, the outer edge 53ce of the central contact zone 53c is parallel and concentric with the inner edge 53pi of the peripheral contact zone 53p. Here, the edges 53ce and 53pi are advantageously circular. Preferably, the edge 53ce of the central zone 53c, the edge 52.1e of the central part 52.1, the edge 51i of the first electrode 51, and the edge 53pi of the peripheral zone 53p are parallel and concentric with each other. Here, they are advantageously circular. The thermistor layer 53 then preferably has a circular shape concentric with the inner edge 53pi of the peripheral contact zone 53p and with the outer edge 53ce of the central contact zone 53c.

A minimal radial distance L for which the thermistor layer is electrically biased can be defined. This radial distance L is defined between the inner edge 53pi of the peripheral contact zone 53p, here of circular shape and of radius Rp, and the outer edge 53ce of the central contact zone 53c, here of circular shape and of radius Rc, such that L=Rp−Rc. It is also possible to define a mean orthoradial distance W, for which the thermistor layer 53 is also electrically biased. This distance W is parallel with the edges 53pi and 53ce and is measured at a position corresponding to Rc+L/2, i.e. at a central radial position of the biased volume of the thermistor layer 53.

Moreover, the thickness h of the thermistor layer can be constant along a radial direction, as illustrated in FIG. 3B. Alternatively, as described hereinafter with reference to FIG. 4B, it can advantageously be higher at the central contact zone 53c and decrease on moving away from it. The thermistor layer 53 then has a dome shape.

An upper protective layer (not shown) may cover the thermistor layer 53, to ensure protection thereof against any contaminations or degradations during the steps of the manufacturing method, like for example the step of stripping the photosensitive resin used to localize the etching of the thermistor layer 53. It may be made of an electrically-insulating material, for example a dielectric material such as a silicon oxide, nitride or oxynitride, or alumina, inter alia, with a thickness of some tens of nanometers.

Moreover, the absorbing membrane 50 comprises an absorber of the electromagnetic radiation to be detected. This absorber is in thermal contact with the thermistor layer 53. It consists of a thin-layer absorber (Salisbury absorber). The material and thickness of the absorber are preferably chosen such that its surface resistance is substantially equal to the impedance of free space. In this example, this absorber is formed by the two electrodes 51, 52. Alternatively, as described hereinafter with reference to FIG. 4B, this absorber can be a thin layer located between the thermistor layer 53 and the upper protective layer. It then extends in the plane XY without being perpendicular to the underlying electrodes.

Thus, the thermal detector 1 has improved performances, in particular in terms of NETD, due to the fact that the so-called looped (here open-loop) geometric configuration of the electrode 51, and therefore of the peripheral contact zone 53p of the thermistor layer 53, allows optimizing the electrical resistance R of the thermistor layer 53, while keeping a sufficient biased volume V so as not to generate more 1/f noise.

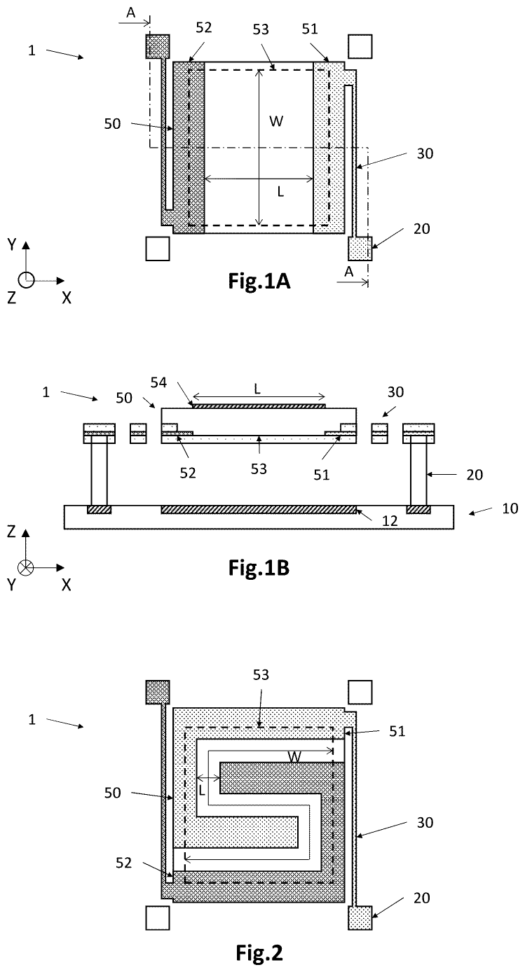

Indeed, this configuration allows obtaining a dimension W much greater than that of the thermal detector of the example of FIG. 1A, while being capable of optimizing the dimension L so as to keep a sufficient biased volume of the thermistor layer 53 in terms of 1/f noise. Moreover, since it is therefore possible to preserve a substantial biased volume through the choice of the L/W ratio, the thickness of the thermistor layer 53 can be reduced compared to usual values, which allows reducing the duration of the step of depositing the thermistor layer and therefore reducing production costs.

FIG. 4A and FIG. 4B are schematic and partial views, respectively as a top view and as a cross-section along the sectional line AA, of a thermal detector 1 according to one alternative embodiment.

The thermal detector 1 here differs from that of FIGS. 3A and 3B essentially in that the electrodes 51, 52 do not have a role of absorbing the electromagnetic radiation to be detected. The distance L is then greater than in the case of FIG. 3A, and a thin-layer absorber 54 is located above the thermistor layer 53. It extends so as not to be perpendicular to the underlying electrodes.

As the distance L is greater, the thin insulating layer 43 may be absent in the radial inter-electrode spacing. On the other hand, it remains present in the orthoradial inter-electrode spacing, i.e. in the angular opening 51.1 of the first electrode 51, so as to prevent any short circuit between the electrodes 51 and 52.

Insofar as the thermistor layer 53 covers and is in contact with the entire central part 52.1 of the second electrode 52, the central contact zone 53c therefore corresponds to the surface of the central part 52.1. The edges 52.1e and 53ce are therefore coincident.

Moreover, the thermistor layer 53 covers and is in contact with the entire inner periphery of the first electrode 51. The peripheral contact zone 53p therefore corresponds to the surface covered by the first electrode 51 from the edge 51i. The edges 51i and 53pi are therefore also coincident.

Finally, the thermistor layer 53 has a radial decrease in thickness h, from the central zone 53c where it has a high value, to the peripheral zone 53p where it has a lower value. To obtain such a shape of the thermistor layer 53, the grayscale lithography technique may be used. This radial thickness variation makes it possible to limit the increase in the current density at the center of the thermistor layer 53, and therefore limit the local increase in 1/f noise.

FIG. 5A is a schematic and partial top view of a thermal detector 1 similar to that of FIG. 3A. It is essentially differentiated therefrom in that the thermistor layer 53 is not in the shape of a complete cylinder, but has a notch 53.1 in the plane XY on an angular sector of angle α. This angular notch 53.1 is located above the radial track 52.2 of the second electrode 52, and above (perpendicular to) the angular opening 51.1 of the first electrode 51. It is advantageous for limiting short circuit risks between the two electrodes 51, 52 in the orthoradial inter-electrode spacing, in particular in the absence of a portion of the upper thin insulating layer 43 in this zone. In the case where the angle α is zero, this configuration is then identical to that of FIG. 3A.

It is possible to estimate the biased volume V of the thermistor layer of a constant thickness h, as well as the associated electrical resistance R, by the following relations:

$$V = ( 1 - \frac{α}{2 π} ) \times π \times ( {Rp}^{2} - {Rc}^{2} ) \times h$$

$$R = \frac{ρ}{h \times ( 2 π - α )} \times ln \frac{Rp}{Rc}$$

FIG. 5B illustrates an example of accessible domains, in terms of biased volume V and electrical resistance R, for the parallelepiped configuration of FIG. 1A (denoted as Cp) and for the circular looped configuration of FIG. 5A (denoted as Cbc). In this example, the thermistor layer has an electrical resistivity ρ equal to 10 Ω·cm, and a constant thickness h equal to 80 nm. It is considered here that the dimension L can vary between 1 and 4 μm, that the dimension W can vary between 4 and 7 μm, that the diameter Rp can vary between 2.5 and 3.5 μm, and finally that the diameter Rc can vary between 500 nm and 2 μm.

It is apparent that the circular looped configuration Cpc makes it possible to address pairs of values (R,V) that are inaccessible with the parallelepiped configuration Cp, both in terms of electrical resistance R and of biased volume V. Thus, in the accessible domain of the parallelepiped configuration Cp, the electrical resistance R remains high. It can here fall below 175 kΩ only in exchange for a relatively low biased volume V, here 0.6 μm³. Conversely, it is possible to increase the biased volume merely to 1.4 μm³, and this results in an increase in the electrical resistance up to 450 kΩ. On the other hand, in the case of a circular looped configuration Cbc with a zero angle α, the accessible domain covers the low values of the electrical resistance R, here up to 100 kΩ for a biased volume which can reach 2 μm³. It is also possible to reach a biased volume of 3 μm³ for an electrical resistance of 300 kΩ.

Moreover, if the two types of configuration are compared more directly, for an electrical resistance R of 175 kΩ, the parallelepiped configuration Cp sets a biased volume of 0.6 μm³, while at this same electrical resistance value, the circular looped configuration Cbc allows obtaining a biased volume of 2.6 μm³, i.e. an increase by more than 300%. Conversely, for a biased volume of 1.4 μm³, the parallelepiped configuration Cp sets an electrical resistance of 450 kΩ, while at this same biased volume value, the circular looped configuration Cbc allows obtaining an electrical resistance of 100 kΩ, i.e. a decrease by 75%.

Moreover, according to one embodiment, the thermistor layer 53 is advantageously configured such that the parameter Z=R×h/ρ is less than or equal to 0.3: Z≤0.3. The thickness h can be a mean value if the thermistor layer 53 exhibits a thickness variation.

Indeed, the inventors observed that, below this value, the annular looped configuration makes it possible to optimize the ratio between the effective biased volume and the geometric volume of the thermistor layer 53, compared to the parallelepiped configuration. The effective biased volume is here evaluated based on the spatial distribution of the electric field in the thermistor layer 53. Optimizing this ratio allows avoiding the current density becoming too substantial at the center of the thermistor layer 53, more specifically at the central contact zone 53c. In particular, this allows limiting the 1/f noise.

For example, for the annular looped configuration, a vanadium oxide thermistor layer 53 with a resistivity p equal to 10 Ω·cm, a constant thickness h equal to 80 nm and a resistance R of 300 kΩ, a parameter Z of 0.24 is obtained. Similarly, for an amorphous silicon thermistor layer of a resistivity ρ of 70 Ω·cm, a constant thickness h of 300 nm and a resistance R of 500 kΩ, a parameter Z of 0.21 is obtained. In these two examples, the ratio is superior in the case of the annular looped configuration compared to the parallelepiped configuration.

Particular embodiments have just been described. Different variants and modifications will become apparent to the person skilled in the art.

Thus, FIG. 6 is a schematic and partial top view of a thermal detector 1 according to another embodiment. In this example, the thermal detector 1 is similar to that of FIG. 3A and is differentiated therefrom essentially in that the electrodes 51, 52 and the thermistor layer 53 have a rectangular (here square) open-loop configuration.

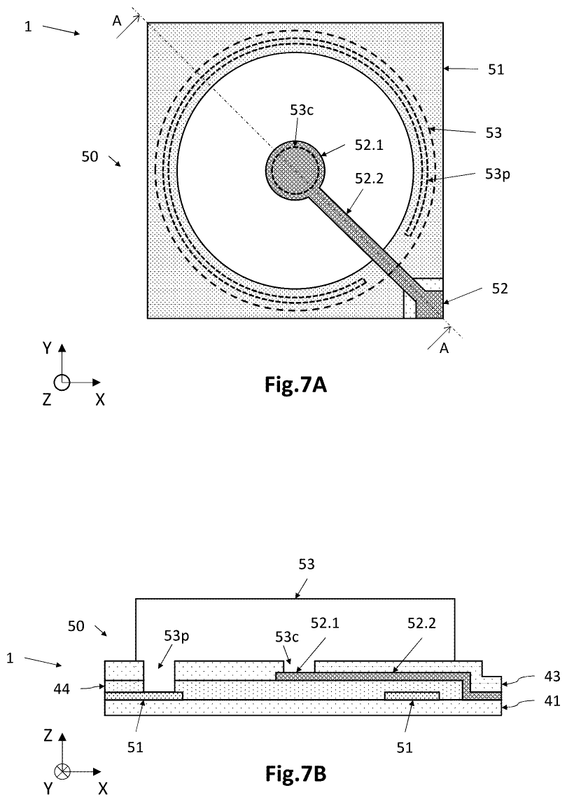

FIG. 7A and FIG. 7B are schematic and partial views, respectively as a top view and as a cross-section along the sectional line AA, of a thermal detector 1 according to another alternative embodiment. The thermal detector 1 here is differentiated from that of FIGS. 3A and 3B essentially in that the electrode 51 extends in a closed loop, and not in an open loop.

The electrode 51 extends continuously along the edge of the absorbing membrane 50. Therefore, it does not have the angular opening 51.1 illustrated in particular in FIG. 3A.

The electrode 52 comprises the central part 52.1 and the radial track 52.2. To avoid any contact with the electrode 51, the radial track 52.2 extends above the electrode 51, and is spaced vertically apart from it by an interposed thin insulating layer 44. The electrode 51 and the radial track 52.2 are therefore not coplanar. Moreover, the central part 52.1 of the second electrode 52 is also located above the electrode 51. It also rests on the interposed thin insulating layer 44. Finally, the upper thin insulating layer 43 covers the second electrode 52 as well as the interposed thin insulating layer 44.

Openings form the central contact zone 53c and the peripheral contact zone 53p. The central contact zone 53c corresponds to an opening made through the upper thin insulating layer 43 which emerges at the central part 52.1 of the second electrode 52. The peripheral contact zone 53p corresponds to an opening made through the upper thin insulating layer 43 and the interposed thin insulating layer 44 and which emerges at the first electrode 51. The material of the thermistor 53 extends into these openings to come into contact with the electrodes 51 and 52. Obviously, the opening of the peripheral contact zone 53p extends in an open loop to avoid emerging at the radial track 52.2.

Note that this closed-loop configuration is similar to the embodiment of FIG. 3A, but it could also apply to the embodiment of FIGS. 4A, 5A and 6. Moreover, the electrodes 51 and 52 may be close to each other (in projection in a plane XY) so as to do without a dedicated absorber 54, or may be away from each other so that the absorber 54 is present.

As mentioned above, the thermal detector 1 according to this alternative embodiment has the same improved performances, in particular in terms of NETD, due to the fact that the so-called looped geometric configuration of the electrode 51 (here closed-loop), and therefore of the peripheral contact zone 53p (open-loop) of the thermistor layer 53, makes it possible to optimize the electrical resistance R of the thermistor layer 53, while retaining a sufficiently biased volume V to not generate more 1/f noise.

In this example, the electrode 52 (central part 52.1 and radial track 52.2) extends above the electrode 51 in a closed loop. Alternatively, the electrode 52 can extend below the electrode 51, i.e. it is located between the thin insulating layers 41 and 44, while the electrode 51 is located between the thin insulating layers 44 and 43. In this case, the opening of the peripheral contact zone 53p can extend in a closed loop because there is no risk of emerging at the radial track 52.2.

1. A thermal detector, comprising:
a readout substrate; and
an absorbing membrane, suspended above the readout substrate, electrically connected and thermally insulated from the readout substrate, the absorbing membrane comprising:
first and second thin-layer electrodes; and
a thermistor layer, disposed on and in contact with the electrodes;
wherein:
the first electrode is a looped track extending along the periphery of the absorbing membrane;
the second electrode is formed of: a central part, disposed at a center of the first loop electrode, and partially surrounded by the first loop electrode; and a radial track from the central part to an edge of the absorbing membrane; and
the thermistor layer includes a peripheral contact zone, extending along the first loop electrode, where the peripheral contact zone is in contact with the first loop electrode; and a central contact zone, disposed at the center of the peripheral contact zone and partially surrounded by the peripheral contact zone, where the central contact zone is in contact with the central part of the second electrode, the thermistor layer being electrically insulated from the radial track.

2. The thermal detector according to claim 1, wherein the peripheral contact zone has an inner edge parallel and concentric with an outer edge of the central contact zone.

3. The thermal detector according to claim 2, wherein the inner edge of the peripheral contact zone and the outer edge of the central contact zone are circular.

4. The thermal detector according to claim 3, wherein the thermistor layer has a circular shape concentric with the inner edge of the peripheral contact zone and with the outer edge of the central contact zone.

5. The thermal detector according to claim 1, wherein the first electrode has an inner edge parallel and concentric with an outer edge of the central part of the second electrode.

6. The thermal detector according to claim 5, wherein the inner edge of the first electrode and the outer edge of the central part of the second electrode are circular.

7. The thermal detector according to claim 1, wherein the absorbing membrane comprises a thin insulating layer disposed between the thermistor layer and the radial track of the second electrode.

8. The thermal detector according to claim 1, wherein the central part of the second electrode is disposed at the center of the absorbing membrane.

9. The thermal detector according to claim 1, wherein the thermistor layer and the electrodes are configured such that a parameter Z=R×h/ρ is less than or equal to 0.3, where R is the electrical resistance of the thermistor layer, h its mean thickness, and p the resistivity of the material of the thermistor layer.

10. The thermal detector according to claim 1, wherein the first electrode and the radial track of the second electrode are coplanar, the first electrode extending in an open loop which comprises an opening wherein the radial track extends.

11. The thermal detector according to claim 10, wherein the thermistor layer has an angular notch disposed vertically above the opening of the first electrode.

12. The thermal detector according to claim 1 wherein the first electrode and the radial track of the second electrode are not coplanar, the first electrode extending in a closed loop, the radial track being spaced vertically apart from the first electrode by an interposed thin insulating layer.
